(19) United States
(12) Patent Application Publication
(10) Pub. No.: US 2009/0258566 A1
(43) Pub. Date: Oct. 15, 2009

(54) Game call

(76) Inventor: James C. May, Rickreall, OR (US)

Correspondence Address: Crowell Ing, LLP, P. O. BOX 923, SALEM, OR, 97308-0923, US

(21) Appl. No.: 12/082,501

(22) Filed: Apr. 11, 2008

(51) Int. Cl. A01M 31/00; A63H 5/00

(52) U.S. Cl. 446/208; 446/207

(57) ABSTRACT

An improved game call for attracting waterfowl, other birds and animals, the preferred embodiment particularly adapted for use in calling ducks. In the preferred embodiment, a mouthpiece is provided with a sounding insert and a receiving collar. By providing a separate sounding insert and receiving collar, materials of varying compositions and densities may be used to construct the game call. Varying materials permit a wider range of tonal qualities and aesthetics. A separate sounding insert similarly permits the mouthpiece to be constructed of materials which may not provide optimal sounding qualities. The game call permits a wide variety of materials, including metal and ornamental woods to be combined for optimal tonal and aesthetic qualities.

### BACKGROUND

1. Background of the Invention

The present invention relates to an improved game call for attracting waterfowl, other birds and animals, the preferred embodiment particularly adapted for use in calling ducks. By providing a separate sounding body and sounding insert, materials of varying compositions and densities may be used to construct the body of a game call. Varying materials permit a wider range of tonal qualities. A separate sounding insert similarly permits the sounding body to be constructed of materials which may not provide optimal sounding qualities. The game call permits a wide variety of materials, including metal and ornamental woods to be combined for optimal tonal and aesthetic qualities.

2. Prior Art

Game calls have been used for many years by hunters, photographers, bird watchers, and others to attract birds such as waterfowl and other animals to the location of the caller. One of the most popular game calls is a duck call. Duck calls are generally constructed of two parts. Duck calls typically have a sound board and reed arrangement that forms a first part and a sounding tube that forms a second part. The two parts are fastened together with a taper lock fit. A particular duck call tune is primarily controlled with the position of the reed relative to the sound board in order to achieve a desired sound. Refinement of the tune and tone of the game call is controlled by the sounding tube in which the sound board and reed assembly are contained. Further refinement and control are through the positioning of the hands of the caller around the game call and the force and duration of air blown through the game call.

The sound generated by a call is affected by the materials used to form the various components. The sound is also affected by the temperature of the components and humidity, or moisture content and exposure. As game calls are often used in a wide variety of temperatures and seasons, and in the case of waterfowl, in close proximity to water, these environmental factors are often an issue. Further complications relate to the use of a callers breath, often high in humidity and warm, to generate a call sound as the caller blows through the call.

Changing temperatures and humidity results in a change in the sound produced by a call and may change the sound so that the call is ineffective. Better call results are achieved through providing a call that maintains a consistent sound through varied conditions.

Taper lock connections between call body parts may also cause problems. If the call is improperly adjusted or dropped, the two connected body parts can become jammed together or loosen or shift, making the call difficult to disassemble, adjust, or varying the sound produced by the call. Varying humidity and temperature may similarly cause the components of a call to expand or contract, altering the seating of the taper lock fit. Components may become loose, or jammed. Over time, wear causes the taper lock connection to change relative body part positions, resulting in a change of sound generated by a game call and eventual loss in utility.

Advances have been made over time to improve game calls. Several are directed to game call construction.

Examples of game calls of this prior art type are described in U.S. Pat. No. 3,406,479 to Faulk and U.S. Pat. No. 4,950,201 to Sceery. Faulk and Sceery show and describe a central groove in the tone board adjacent to the reed. Ledge in U.S. Pat. No. 4,138,800 describes flaring the central groove in the tone board to reduce back pressure and quickens removal of moisture build up from the tongue portion of the call.

U.S. Pat. No. 4,888,903 to Knight shows and describes the use of an O-Ring seal between the mouthpiece and the sound assembly to prevent air from flowing through the joint between those members. Sceery in U.S. Pat. No. 4,950,201 describes making the mouthpiece from a resilient material, preferably rubber, and provides a raised circular rib on the sound assembly that engages the mouthpiece to provide a similar function.

U.S. Pat. No. 2,604,731 to Meucci provides a duck call that has some parts that are connected together using a threaded connection. A spring is employed as part of a mechanism to tune the duck call.

U.S. Pat. No. 2,825,180 issued to H. E. Dieckmann discloses a bird call that is comprised of two sections that are threadably engaged as shown in FIGS. 2 and 3 of the '180 patent. A reed is sandwiched between a pair of longitudinally extending tongues that are held by an outer housing. The device includes five basic parts that include the two tongue members, the reed, and the outer housing that is provided in two sections that are threadably engaged.

U.S. Pat. No. 3,928,935 to Beadles discloses a game calling device formed of two parts, one a hollow barrel configured member having a mouthpiece at one end, and an air chamber passing therethrough for mating in friction engagement with a keg-contoured member terminating in a truncated portion formed by at least two surfaces, a pair of cylindrically shaped passages extending through the keg portion and each cylindrical passage receiving a set of vibrating reed elements therein. The mating surfaces are retained in friction engagement by means of an O-ring that fits within an annular groove, and the truncated portion is adapted to fit and facilitate being received in an operator's hand so that alternatively the operator's fingers, may completely or partially close off one or the other of the cylindrically shaped openings that extend from the truncated portion.

U.S. Pat. No. 4,737,130 to Mann discloses a short mouthpiece for a goose call that is provided with a bushing which telescopically mounts in the mouthpiece bore.

### BRIEF SUMMARY OF THE INVENTION

The present invention provides an improved game call that may be constructed of a wide variety of materials for improved game call sound, and aesthetics. The present invention provides an improved game call sound that is consentient over a wide variety of temperatures and moisture conditions and is resistant to jamming or other difficulties that are common to taper lock game calls.

The present invention features a two part body that includes a tubular mouthpiece and tubular sound assembly that each have a central bore. The two part body provides an elongated open-ended bore when the two hollow tubular members are assembled together. Both the components and the assembled body have opposed air receiving and air discharge end portions.

A first tubular member or mouthpiece defines the air receiving opening located at the air receiving end portion of the game call body.

A second tubular member defines an air discharge opening located at the air discharge end portion of the game call body. The second tubular member is further comprised of a sounding board and reed assembly.

A receiving collar is placed in the air discharge end of the tubular mouthpiece. The receiving collar is for receiving the tubular sound assembly, preferably by means of a taper lock.

Co-axially inserted into the tubular mouthpiece is a sounding insert.

### OBJECTS OF THE INVENTION

One object of this invention is to improve the sound of a game call.

Another object of this invention is to provide a game call that may be operated in thermally varied environments with better control over the tone of the call.

Yet another object of this invention is to provide a game call that may be operated in wet or humid conditions with better control over the tone of the call.

Yet another object of this invention is to provide a game call that may constructed of a wide variety of materials for improved sound and aesthetics.

Yet another object of this invention is to provide a game call that may constructed of a wide variety of materials yet maintain the integrity and function of a traditional game call taper lock.

Although the preferred embodiment of the present invention is for a duck call, the invention has broader application to bird and animal calls and sounding devices.

In accordance with these and other objects which will become apparent, the invention will now be described with reference to the accompanying drawings.

### BRIEF DESCRIPTION OF THE DRAWINGS

FIG. 1 is a side view of the assembled game call.

FIG. 2 is a cross-sectioned view of the assembled game call in the direction of arrows 2-2 shown in FIG. 1.

FIG. 3 is an exploded view of the game call showing the components.

### DETAILED DESCRIPTION OF THE INVENTION

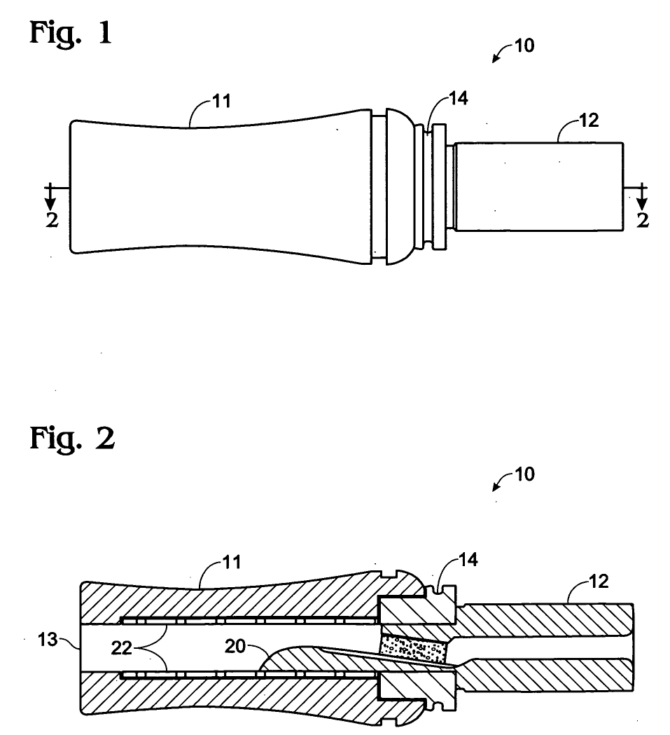

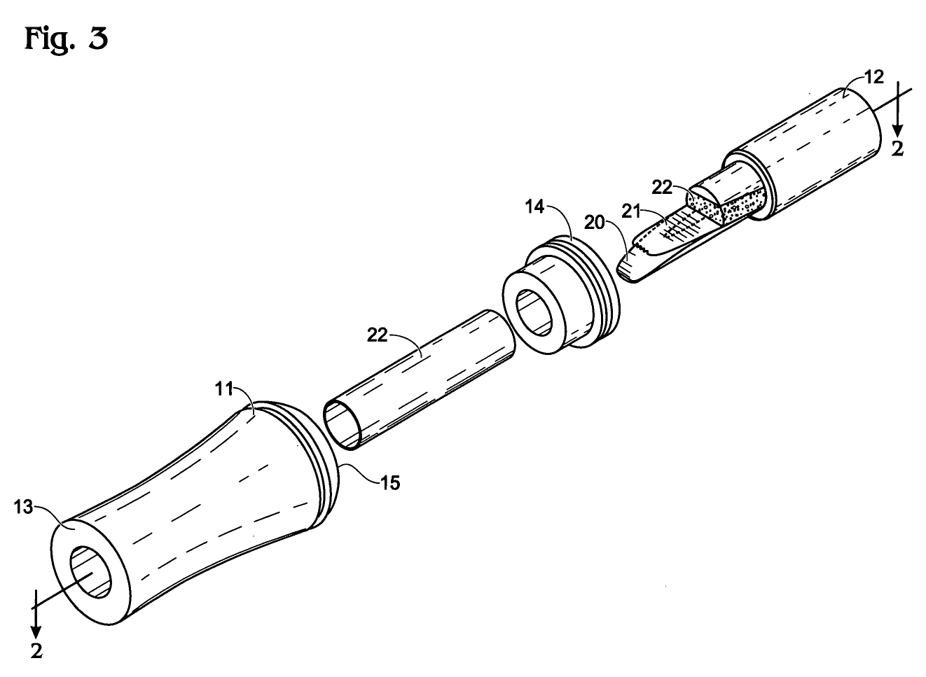

Referring now to the drawings, the present invention is shown generally as numeral 10 in FIGS. 1 and 2. The game call 10 is designed to produce the sounds of ducks, but may be applied to calls made for other waterfowl, birds, and animals. The game call 10 in the preferred embodiment, is made of a combination of synthetic and natural materials.

In the preferred embodiment, a tubular mouthpiece 11 with a central bore is comprised of an aesthetically pleasing wood. A tubular sound assembly 12 with a central bore is preferably formed of a single molded piece of synthetic material. The tubular sound assembly 12 preferably comprises a tone board 20, a reed 21, and a reed retainer 22.

Further components include the receiving collar 14 formed of a compatible synthetic material for receiving the tubular sound assembly 12 in a taper lock. The receiving collar is preferably affixed to the mouthpiece 11 by means of glue, but may also be threadedly attached or attached with other securing means. Through use of a receiving collar made of a material that is compatible with the sound assembly 12, thermal and humidity driven contraction and expansion can be limited in their detrimental effects to the forming and maintaining of a useful taper lock in the game call components.

A further improvement over the prior art is through the use of the sounding insert 22 fitted to the central bore of the mouthpiece 11. In the preferred embodiment, the sounding insert 22 is made of brass to provide a bright edge to the game call sound, but other materials such as stainless steel and resin may be used. The material of the sounding insert 22 may be a harder or softer material depending on the sound desired.

The sounding insert may be removable, or affixed though use of glue or friction lock. A principal benefit of the disclosed game call is the ability to utilize an aesthetically pleasing wood in a game call without the shortcomings of wood. In contrast to plastic game calls, wood game calls absorb moisture and change shape and tone as moisture is absorbed. Wood game calls are also subject to varying degrees of thermal expansion.

A benefit of the present invention resides in the use of a synthetic material type sound assembly 12 and receiving collar 14 in conjunction with a sounding insert 22. Isolation of one or more of these components permits the mouthpiece 11 to be made of any suitable material including natural woods which may not otherwise be suitable for a game call or which may suffer the limitations of natural components.

Further benefits include the ability to use a wide variety of materials that have differing costs and machineability, yet though the use of a sound assembly 12 and compatible receiving collar 14 pair and a distinct sounding insert 22, a wider range of materials and fabrications methods may be utilized for the various components of a game call 10.

The game call 10 includes a tubular mouthpiece shown generally at numeral 111 with a central bore and a tubular sound assembly shown generally at numeral 12 with a central bore, the two pieces joined co-axially when assembled as shown in FIG. 1, the game call 10 imitates a duck when air is blown through the air receiving end 13 of the mouthpiece 11.

To assemble the game call 10, the sounding insert 22 is fitted inside the mouthpiece 11 ad shown in FIG. 3. The receiving collar 14 is then inserted into the air discharge end 15 of the mouthpiece and affixed though use of glue or similar means. A reed 21 is placed on the tone board 20 portion of the tubular sounding assembly 12 and held in place by a reed retainer 22. The reed retainer 22 is typically made of cork, but other resilient materials may be used. The reed 21 in the present invention is made from a thin flexible material such as MYLAR™ by DuPont. The assembled tubular sound assembly 12 is then inserted into the receiving collar 14 until held in place with a friction tight taper lock.

When properly assembled, all principal components, 11, 22, 14, 12 are coaxial aligned as depicted in the exploded view of FIG. 3.

While the instant invention has been shown and described herein in what are conceived to be the most practical and preferred embodiments, departures may be made therefrom within the scope of the invention, which is therefore not to be limited to the details disclosed herein, but is to be afforded the full scope of the claims so as to embrace any and all equivalent apparatus and articles.

The terms and expressions which have been employed in the foregoing specification are used herein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A game call comprising:
A first tubular mouthpiece having a bore, an air receiving end and a discharge end,
A sounding insert fitted within said mouthpiece bore,
A receiving collar fitted to said mouthpiece discharge end,
and a second tubular sound assembly having a bore,
said sound assembly having a tone board and a reed attached by a reed retainer,
said sound assembly fitted to said receiving collar.

2. The game call of claim 1 wherein:
said mouthpiece is comprised of wood.

3. The game call of claim 1 wherein:
said sound assembly is comprised of synthetic material.

4. The game call of claim 1 wherein:
said sounding insert is comprised of metal.

5. The game call of claim 1 wherein:
said sound assembly fitted to said receiving collar by means of a taper lock.

6. A game call comprising:
A first tubular mouthpiece having a bore, an air receiving end and a discharge end,
A sounding insert fitted within said mouthpiece bore,
and a second tubular sound assembly having a bore,
said sound assembly having a tone board and a reed attached by a reed retainer,
said sound assembly fitted to said mouthpiece.

7. The game call of claim 6 wherein:
said mouthpiece is comprised of wood.

8. The game call of claim 6 wherein:
said sound assembly is comprised of synthetic material.

9. The game call of claim 6 wherein:
said sounding insert is comprised of metal.

10. The game call of claim 6 wherein:
said sound assembly fitted to said mouthpiece by means of a taper lock.

11. A game call comprising:
A first tubular mouthpiece having a bore, an air receiving end and a discharge end,
A receiving collar fitted to said mouthpiece discharge end,
and a second tubular sound assembly having a bore,
said sound assembly having a tone board and a reed attached by a reed retainer,
said sound assembly fitted to said receiving collar.

12. The game call of claim 11 wherein:
said mouthpiece is comprised of wood.

13. The game call of claim 11 wherein:
said sound assembly is comprised of synthetic material.

14. The game call of claim 11 wherein:
said sound assembly fitted to said receiving collar by means of a taper lock.
